(19) United States
(12) Patent Application Publication
(10) Pub. No.: US 2006/0277014 A1
(43) Pub. Date: Dec. 7, 2006

(54) Dairy production information system

(75) Inventors: Andrew Loder, Bellingham, WA (US); Michael J. Jerred, Elk River, MN (US); William Michael Craig, Monticello, MN (US); Michael A. Messman, Becker, MN (US); David M. Larson, Wayzata, MN (US)

Correspondence Address: CARGILL, INCORPORATED, LAW/24, 15407 MCGINTY ROAD WEST, WAYZATA, MN, 55391, US

(73) Assignee: CAN Technologies, Inc.

(21) Appl. No.: 11/402,214

(22) Filed: Apr. 11, 2006

Related U.S. Application Data
(60) Provisional application No. 60/670,852, filed on Apr. 13, 2005.

(51) Int. Cl. G06G 7/58

(52) U.S. Cl. 703/11

(57) ABSTRACT

A method for allocating dairy end product pricing risk in a dairy production system is described. The method includes providing a fixed price for a future period for a dairy end product to a retailer of the dairy end product, determining a cost of production for the dairy end product, the cost of production including costs associated with each dairy production entity in the dairy production process, and allocating the difference between the fixed price and the cost of production among each dairy production entity based on the sale of the dairy end product at the fixed price.

### CROSS REFERENCE TO RELATED PATENT APPLICATIONS

This application claims the benefit of U.S. Provisional Application No. 60/670,852 filed Apr. 13, 2005, hereby incorporated by reference in its entirety.

### BACKGROUND

The present application relates generally to the field of systems and methods for generating and tracking information in a vertically integrated dairy production system. More specifically, the present application relates to a dairy production information system configured to facilitate information transfer and agreements between and among entities associated with a vertically integrated dairy production system.

Coordination of information flow in the dairy production industry is often desultory or non-existent. The lack of coordination between the entities in a dairy production system can have an adverse effect on many different aspects of the dairy production, including, but not limited to allocation of pricing risk among the entities, tracking of information associated with production, implementation of quality control procedures, setting of production levels, quality expectations, etc.

For example, a lack of coordination among the entities in a dairy production system may have an adverse effect of the entities ability to set a fixed price for a dairy production system end product, such as cheese, ice cream, butter, yogurt, etc. Without coordination, prices for dairy production end products are highly volatile because the constraints faced by the dairy industry are highly volatile. Further, the constraints a systemic and are experiences by all of the entities in a dairy production chain. A dairy production chain may include multiple entities, such as an animal feed producer, a farmer/milk producer, a distributor, a dairy processor, and a dairy end product retailer, each of which experiences their own volatility. Currently, each entity bears its own risks for the volatility because of the lack of information flow and/or vertical integration to share and/or mitigate the pricing risk.

According to yet another example, lack of coordination interferes with the ability of the dairy production system to satisfy the higher demands that consumers and food retailers are placing on dairy producing entities. Consumers and retailers are seeking more in terms of food quality, food safety to avoid contamination, bioterrorism, or other concerns, and food freshness. Providing this information and/or satisfying the higher standards requires a greater coordination and flow of information between the dairy production entities.

What is needed is a dairy production information system configured to allow dairy production entities to share information and/or make agreements to satisfy one or more criteria demanded by a dairy end product retailer. What is further needed is such a system configured to allow allocation of pricing risk, generation of dairy end product tracking, and/or setting of production levels for a particular end product having one or more specified characteristics.

### SUMMARY

One embodiment relates to a method for allocating dairy end product pricing risk in a dairy production system. The method includes providing a fixed price for a future period for a dairy end product to a retailer of the dairy end product, determining a cost of production for the dairy end product, the cost of production including costs associated with each dairy production entity in the dairy production process, and allocating the difference between the fixed price and the cost of production among each dairy production entity based on the sale of the dairy end product at the fixed price.

Another embodiment relates to a system for managing dairy production information in a dairy production system. The system includes a dairy information system including a plurality of dairy end product records, wherein each dairy end product record is associated with a particular dairy end product and includes dairy production information related to the dairy end product from each stage of a dairy production process used to generate the dairy end product.

Another embodiment relates to a method for producing a dairy end product having end product requirements. The method includes determining a method of dairy production configured to generate a dairy end product having characteristics that satisfy the end product requirements and optimize profitability, determining an allocation of production outputs for implementation of the dairy production method among the entities in a dairy production system; and determining an allocation of the profitability based at least in part on the costs associated with the allocated production outputs allocated to each of the entities in the dairy production system.

Other features and advantages of system and method described in the present application will become apparent to those skilled in the art from the following detailed description and accompanying drawings. It should be understood, however, that the detailed description and specific examples, while indicating preferred embodiments, are given by way of illustration and not limitation. Many modifications and changes within the scope of the present application may be made without departing from the spirit thereof, and the application should be read to include all such modifications.

### BRIEF DESCRIPTION OF THE DRAWINGS

FIG. 1 is a dairy production system flowchart illustrating entities in a dairy production system and the flow of work/materials in producing a dairy end product, according to an exemplary embodiment;

FIG. 2 is a flowchart illustrating formation of a dairy production agreement configured to commit the entities in the dairy production system of FIG. 1 to information and pricing risk sharing, according to an exemplary embodiment; and

FIG. 3 is a block diagram illustrating a dairy production computing environment having a plurality of computing systems associated with dairy production entities, according to an exemplary embodiment.

### DETAILED DESCRIPTION

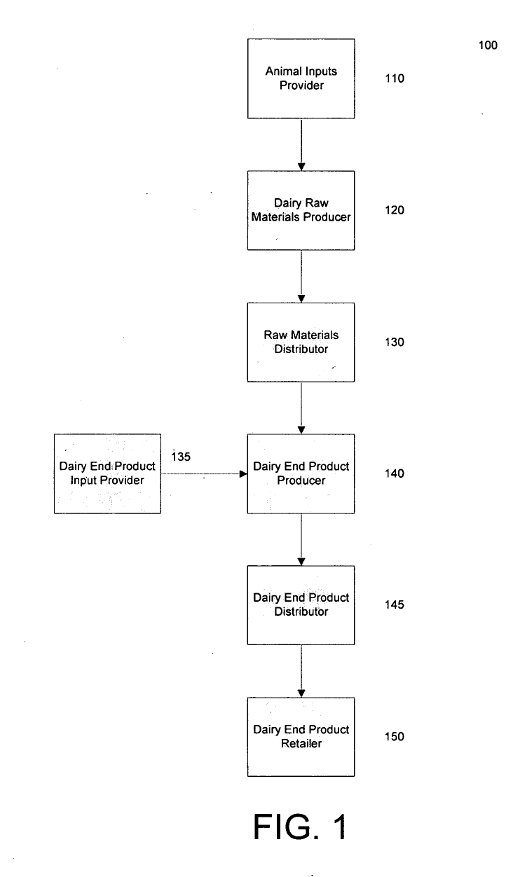

Referring to FIG. 1, a dairy production system 100 flowchart illustrating entities in a dairy production system and the flow of work/materials in producing a dairy end product is shown, according to an exemplary embodiment. Dairy production system 100 includes an animal feed producer 110, a dairy raw materials producer 120, a distributor 130, a dairy end product input provider 135, a dairy end product producer 140, a dairy end product distributor 145, and a retailer 150.

Although the entities in dairy production system 100 are shown are described herein as separate entities performing specific functions, it should be understood that a single entity may perform the functions of more than one entity, multiple entities may perform the functions associated with a single entity herein, an entity may perform one or more functions associated with a different entity, etc. Further, dairy production system 100 may include more, less, or a different ordering of entities to perform the functions described herein. For example, raw materials distributor 140 may be involved with distribution from a dairy raw material producer as well as distribution from a dairy end product producer.

Animal inputs provider 110 may be any entity or combination of entities that provide inputs to dairy raw materials producer 120 to generate the dairy raw materials, further described below. For example, animal inputs provider 110 may be a dairy animal sales agent, an animal feed producer, a dairy production equipment provider, a dairy facilities builder, etc. Animal inputs provider 110 may be any entity providing one or more inputs used by dairy raw materials producer 120 to generate the dairy raw materials.

According to an exemplary embodiment, the animal inputs that are provided by animal inputs provider 110 may vary depending on requirements stipulated by one or more other entities within dairy production system 100. Each requirement may be associated with a specific cost. For example, a dairy end product producer may be required to provide a dairy end product having a higher level of protein. In order to satisfy the protein level requirement, it may be necessary to provide an animal feed having higher amounts of certain ingredients. These ingredients may be associated with an increase or decrease in the overall cost of the animal feed.

Providing different ingredients in an animal feed may change the animal feed characteristics and eventually have an effect on the dairy end product that is produced. The nutritional composition of a feed ingredient can be used in combination with the nutritional composition of every other ingredient in the animal feed to produce an animal feed that optimizes some characteristic such as the production of the animal and/or economic return. Animal feed producers have recognized that certain nutritional compositions help animals to produce more than if they used other nutritional compositions. Additionally, animal feed producers have recognized that high amounts of certain nutrients can actually impede the production rate of an animal. Further, animal feed producers have recognized that optimal nutritional composition changes may depend on the production stage of the animal in question (e.g. producing, resting, recovering, etc.). The ideal nutrient composition can also change based on additional factors, including the health of the animal and whether the animal is nursing. Therefore, animal feed producers have recognized that by mixing ingredients to produce an ideal nutritional composition for particular animals at particular growth stages, they can alter the dairy end product quality, characteristics, and/or volume.

The costs associated with animal inputs provision are highly variable and dependent on external factors. For animal feed inputs, the costs may depend on crop production rates, delivery costs, current demand, current events, market speculation, etc. For other inputs, the costs may be equally variable based on current demand, raw materials required to produce the inputs, etc. The volatility associated with the costs may be smoothed based on the contributions of other entities in dairy production system 100. For example, wherein costs are currently too high for a particular ingredient needed to provide a high grade animal feed, it may still be possible to provide a high grade dairy end product by using a high grade distribution process that minimizes any grade decay that would otherwise normally occur using a low grade distribution process.

Dairy raw materials producer 120 may be any entity or combination of entities that receive the animal inputs provided by animal inputs provider 110 to generate the dairy raw materials. For example, dairy raw materials producer 120 may be a farmer having a herd of dairy cows that produce unprocessed milk that is used to create the dairy end products. Another exemplary dairy raw material may include concentrated milk solids created by the removal of some of the water in milk through various systems.

According to an exemplary embodiment, one or more characteristics of the raw materials that are produced may also vary depending on requirements stipulated by one or more other entities within dairy production system 100. Each requirement may again be associated with a specific cost. For example, in order to satisfy the high protein level requirement for the dairy end product described above, it may be necessary to first purchase an animal feed having higher amounts of certain ingredients, and also to use a different feed regimen than normal. The different feeding regimen may be associated with an increase or decrease in the overall cost of the dairy raw materials based on labor requirement, production rates, etc.

It may be possible to reduce and/or avoid some of the costs by changing the requirements of other entities in dairy production system 100. For example, requiring a higher grade of animal feed from animal inputs provider 110 may reduce the intensity of the feeding regimen necessary to satisfy a raw materials requirement.

Similar to animal inputs provider 110, different steps taken by dairy raw materials producer 120 may change the characteristics associated with the dairy raw materials and eventually have an effect on the dairy end product that is produced. Raw materials producers have recognized that certain production regimes, such as feeding rates, types of animals, equipment used, etc. help animals to produce more than if they used other production regimes.

The costs associated with raw materials provision are similarly highly variable and dependent on external factors. For raw material production, the costs may depend on timing of production, delivery costs, shelf life, current events, market speculation, the cost of the animal inputs described above, etc. Dairy cattle, being ruminants, consume from 40 to 60% of their diet as forage. This portion of the diet can be highly variable and other inputs are dependent on this forage portion.

Advantageously, wherein dairy production system 100 includes both animal inputs provider 110 and dairy raw materials producer 120, the provision of the animal inputs may be coordinated with the raw materials production to optimize efficiency. For example, dairy raw materials producer 120 may coordinate with animal inputs provider 110 to satisfy a requirement stipulated by one or more of the entities in dairy production system 100. This variable may be compensated for by using concentrated and/or targeted animal feed inputs provided animal inputs provider 110 to satisfy raw materials requirements. Efficiencies may be realized by anticipating demand, reducing volatility, sharing information, etc.

For example, one of the biggest factors driving pricing risk in a dairy production system is the investment cost in dairy. The dairy industry has a high cost per production unit. The cost for a productive dairy cow may be in the $1400 to $2500 range per animal. In addition to the cost of the animal, there is a high investment cost in the dairy facilities as well. Once again there is a wide range but investment in housing, land, and parlor can run between $2000 and $5000 per cow. Further, dairy raw materials producers also experience difficulties in managing animal inventories based on market conditions because of the long productive life of the dairy animal and the high facility cost. In a dairy production system, it is very difficult to ratchet down production in a price poor environment. Providing production level coordination among the entities in dairy production system 110 may reduce this type of volatility and/or risk.

Yet further, the dairy production industry has not settled on standard production systems and best practices are developed on an operation by operation basis. Information flow among the entities in dairy product system 100 may reduce this type of risk by encouraging the free exchange of information.

Raw materials distributor 130 may be any entity or combination of entities that receive raw materials provided by dairy raw materials producer 120 and distribute the raw materials to a dairy end product producer 140. For example, raw materials distributor 130 may be a storage/trucking company having a storage facility and fleet of vehicles configured to store and transport the raw materials used to create the dairy end products under specific conditions.

According to an exemplary embodiment, the raw materials that are delivered may also vary depending on requirements stipulated by one or more other entities within dairy production system 100. Each requirement may again be associated with a specific cost. For example, in order to satisfy the high protein level requirement for the dairy end product described above, it may be necessary to store the raw materials at a specific temperature and to deliver the raw materials to dairy end product producer 140 within a specific time frame. The different handling requirements may be associated with an increase or decrease in the overall cost of the dairy raw materials based on storage facilities required, number of vehicles required, etc.

It may be possible to reduce and/or avoid some of the costs by changing the requirements of other entities in dairy production system 100. For example, requiring a different raw materials type from dairy raw materials producer 120 may reduce the storage requirement. For example, if the raw materials that are received have an ultra high grade to satisfy a requirement, some decay may occur during storage under less stringent requirements while still satisfying requirements stipulated by a dairy end product producer.

Again, different steps taken by a distributor may change the characteristics associated with the dairy raw materials and eventually have an effect on the dairy end product that is produced. Raw materials producers have recognized that certain storage methods, delivery time frames, etc. have an effect on the raw materials that are delivered.

The costs associated with raw materials distribution are similarly highly variable and dependent on external factors. For raw material distribution, the costs may depend on amount of production, energy prices, shelf life, current events, market speculation, the cost of the animal inputs described above, etc.

Advantageously, wherein dairy production system 100 includes both animal inputs provider 110, dairy raw materials producer 120, and raw materials distributor 130, the provision of the animal inputs and raw materials may be coordinated with the distribution of the raw materials production to optimize efficiency. For example, dairy raw materials distributor 130 may coordinate with animal inputs provider 110 to satisfy a requirement stipulated by one or more of the entities in dairy production system 100. As stated above, efficiencies may be realized by anticipating demand, reducing volatility, sharing information, reducing transportation costs, etc.

Dairy end product input provider 135 may be any entity or combination of entities that provide end product inputs to dairy end product producer 140, further described below, to be used in the product of the dairy end product. Exemplary dairy end product inputs may include processing equipment, processing facilities, dairy end product preservatives, nutritional additives, etc. Dairy end product inputs may include anything used in producing the dairy end product other than the dairy raw materials. Dairy end product input provider 135 operates and faces volatility similar to animal inputs provider 110, as described in further detail above.

Dairy end product producer 140 may be any entity or combination of entities that receive the dairy raw materials and dairy end product inputs and produces a dairy end product for dairy end product retailer 150. For example, dairy end product producer 140 may be a cheese maker that uses milk as a raw material to make various types of cheese having a variety of characteristics.

According to an exemplary embodiment, the end products that are produced may also vary depending on requirements stipulated by one or more other entities within dairy production system 100. Each requirement may again be associated with a specific cost. For example, in order to satisfy the high protein level requirement for the dairy end product described above, it may be necessary to use a particular cheese making process using specialized production equipment. The specialized equipment and/or process may be associated with an increase or decrease in the overall cost of the dairy end product.

It may be possible to reduce and/or avoid some of the costs by changing the requirements of other entities in dairy production system 100. To continue the example above, requiring a different raw materials type from dairy raw materials producer 120 may also reduce the end product processing requirements. For example, if the raw materials that are received have an ultra high level to satisfy a requirement, some decay may occur using a production process having less stringent requirements while still satisfying requirement stipulated by a dairy end product retailer.

Again, different steps taken by a producer may change the characteristics associated with the dairy end product that is produced. Raw materials producers have recognized that processing methods, specialized equipment, storage methods, etc. have an effect on the dairy end products that are delivered.

The costs associated with dairy end product production are similarly highly variable and dependent on external factors. For end product production, the costs may depend on amount of production, energy prices, shelf life, current events, market speculation, the cost of the end product inputs described above, etc. On the processing side there are a couple of differentiation points increasing the volatility associated with production. First is the short shelf life of dairy (particularly milk). This removes any possibility for a producer to control when he sells his product. It must be delivered basically every day. Processors also work to create products they are set up to run to reduce transition costs. In most cases, this processing will create some byproduct that either creates a waste stream or a second product line. Potential value exists with processors to help them control the nutrient composition of the milk they receive to minimize or maximize the byproduct production.

Advantageously, wherein dairy production system 100 includes both animal inputs provider 110, dairy raw materials producer 120, raw materials distributor 130, and dairy end product producer 140, the provision of the dairy end product may be coordinated with the provision of the raw materials to optimize efficiency. For example, dairy end product producer 140 may coordinate with dairy raw materials producer 120 to satisfy a requirement stipulated by one or more of the entities in dairy production system 100. As stated above, efficiencies may be realized by anticipating demand, reducing volatility, sharing information, etc.

Dairy end product distributor 145 may be any entity of combination of entities that distribute the dairy end product inputs to dairy end product retailer 150, further described below, to be sold. Dairy end product distributor 145 operates and faces volatility similar to dairy raw materials distributor 130, described in further detail above.

Dairy end product retailer 150 may be any entity or combination of entities that agrees to buy the dairy end product from dairy end product producer 140. Retailer 150 may sell the dairy end product directly, such as in a grocery store, a cheese store, an ice cream shop, etc. or as a part of some other product, such as a fast food provider, where the fast food includes the dairy product, like a cheeseburger.

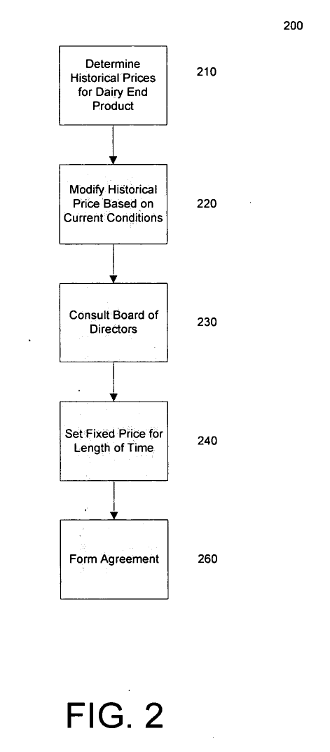

Referring now to FIG. 2, a dairy agreement formation flowchart 200 illustrating formation of a dairy production agreement configured to commit the entities in dairy production system 100 to information and risk sharing is shown, according to an exemplary embodiment. The agreement may be embodied in a contractual agreement. Although the agreement may be related to any type information distribution commitment, agreement is shown in FIG. 2 and described herein with reference to a pricing risk allocation agreement.

Generally, the steps in dairy agreement formation flowchart 200 may be performed by an individual, such as a third party arbiter between retailer 150 and the other entities in dairy production system 100, an individual entity such as dairy end producer 140, or representatives from all of the entities of dairy production system 100, such as a board of directors. Each step may also be performed by each entity for eventual aggregation. The individual, entity, or collection of entities will be referred to hereinafter as the formation entity. It should be understood that the formation of the agreement may alternatively include more, fewer, and/or different steps to achieve the functionality described herein.

In a first step 210, the formation entity may consult historical prices to determine an initial starting point in setting a fixed price for providing a dairy end product to retailer 150 for a determined length of time. The historical prices may be modified based on current and/or forecasted market conditions in a step 220. Current and or forecasted market conditions may include, but are not limited to, commodity pricing (for example of the Chicago Board of Trade, forward commodity prices, etc.), input pricing, end product demand, etc.

The initial starting point may be set by retailer 150 providing the remaining entities of dairy production system 100 with a “take it or leave it” fixed price that is non-negotiable. This fixed price may be set up front based on consumer price points, retailer desired profitability, etc. or it may be set following production entity negotiation in step 230, further described below.

After the price is set based on historical and external inputs, the entities within dairy production system 100 may be consulted in a step 230. Consultation may include negotiation with the other entities based on a desired level of profitability. Each entity may individually determine a desired profitability or a return on equity. However, the fixed price is defined the available profitability or return is limited. Because cost information is relatively available in the information, an equitable allocation of profitability may be easier to negotiate. Each entity may determine a price to be paid in both purchasing inputs from an upstream entity in the dairy production chain and a price to be received in selling outputs to a downstream entity in the dairy production chain.

If the price was not previously set, the fixed price may be determined based on the negotiations and/or allocations of step 230 in a step 240. The fixed price may further be associated with a length of time wherein the fixed price will remain in effect. Increasing the length of time increases the risks for the dairy product producers.

The final agreement including the fixed price, timing information, and negotiated price/risk allocation may be formalized in a step 260. Formalizing the agreement may include execution of contracts, actual sales, etc.

Although a formal agreement is shown and described, the agreement that is formed may be inherent in the dairy production process. For example, dairy raw materials producers 120 may require that animal feed input providers 110 include the required tracking, quality control, pricing, etc. information along with the animal inputs that are provided. This information may then be associated with the raw materials that are produced and used throughout the remainder of the dairy production process.

The agreement may further include an end product pricing risk allocation. For example, the agreement may be associated with a commitment to provide a dairy end product at a fixed price set by an agreement between dairy end product producer 140 and retailer 150. The fixed price may be a static fixed priced or a variable fixed price that is set based on an easily identifiable external factor. For example, a fixed price may be a percentage over commodity price. In setting the fixed price, all entities in the dairy production system 100 responsible for providing the dairy end product may provide information needed to establish an optimal fixed price. For example, a production system board of representatives from various levels within the production chain may be used in setting the price. Alternatively, the price may be set by an individual, or any combination of groups and individuals.

The fixed price may be set for a specific time period extending into the future. The fixed price may further be associated with a start time and an end time. For example, retailer 150 may agree to pay a specified price for a dairy end product from a current time and for the next two years. The farther into the future the fixed price extends, the greater the risk associated with the fixed price.

Thereafter, each entity within dairy production system 100 may agree to a pricing risk. Each entity may agree to more or less pricing risk depending on their risk tolerance. In practice, profitability may be strongly tied to the risk undertaken by the entities. For example, an entity within dairy production system may commit to providing a specific output independent of the inputs received. Accordingly, that entity may be required to use more expensive processes and/or materials to satisfy the output requirements if a change occurs in the input materials that are provided. Advantageously, an entity may manage their own risk but undertaking the risk in some production cycles while mitigating risks in other production cycles.

The risk allocation may further be managed wherein every entity within the production chain is aware of changes in underlying constraints and the effect that it will have at each stage along the production chain. For example, where a fixed price has been set for a particular dairy end product has been set and the cost of a required ingredient in producing the dairy end product has increased dramatically, it may be possible to spread that cost among the entities of dairy production system 100. Where the price of an animal feed input has increased dramatically, for example following a natural disaster that adversely affected crop yields, the reduced profitability in providing the end product at the fixed price may be spread among all of the entities in dairy production system 100 rather than being allocated solely to raw materials provider 120 when purchasing the animal feed input.

The information may further aid entities within dairy production system 100 in meeting end product requirements. For example, wherein specific dairy end product, such as a grade of cheese, is required to have specific nutrient levels to satisfy specific fatty acid requirements, it may be possible to satisfy that requirement based on steps taken by multiple entities in dairy production system 100. Increasing the fatty acid level for a cheese may be accomplished by modifying the animal feed provided to the animal (modifying the expenses of animal inputs provider 110), changing the feeding regimen for an animal (modifying the expenses of dairy raw materials producer 120), reducing the storage and/or transportation time of the milk produced (modifying the expenses of distributor 130), changing the processing method (modifying the expenses of dairy end product producer 140), etc.

According to an exemplary embodiment, dairy production system may be configured such that raw materials produced by dairy raw materials producer 120 are associated not only with an identifier for dairy raw materials producer 120, but also with an identifier of animal inputs provider 110 that provided the inputs used to produce the specific raw materials. Advantageously, associating both the raw materials producer and the animal inputs provider with the raw materials facilitates tracking for quality control, safety concerns, accounting, etc. For example, wherein a dairy end product has been contaminated, tracking the source of the contamination will be much easier if the end product is clearly associated with each of the specific entities in dairy production system 100 that produced the end product.

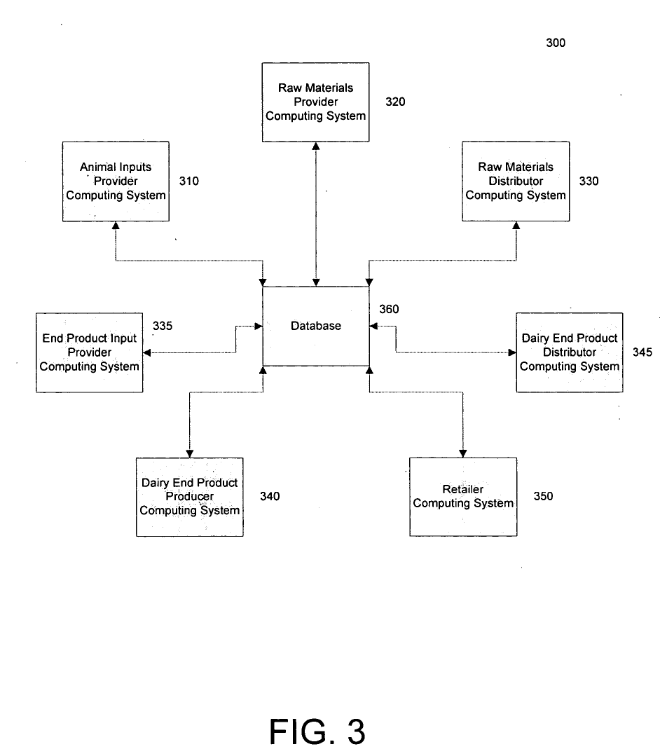

Referring now to FIG. 3, a block diagram illustrating a dairy production information system 300 is shown, according to an exemplary embodiment. Dairy information system 300 is configured to facilitate the flow and storage of information between the entities associated with dairy production system 100. Dairy information system 300 may be any type of computing system including a database configured to perform the functionality described herein.

Dairy information system 300 includes computing systems associated with each entity of dairy product system 100, including an animal inputs computing system 310, a dairy raw materials producer computing system 320, a raw material distributor computing system 330, a dairy end product input provider computing system 335, a dairy end product producer computing system 340, a dairy end product distributor computing system 345, and a retailer computing system 350. The computing system may be any type of computing system configured to communicate with the other computing system in dairy information system 300 and a database 360.

Dairy information system 300 may further include database 360 configured to maintain a plurality of dairy end product records 365. Database 360 may be implemented using any type of database system, including, but not limited to, traditional database software systems, spreadsheet, word processing programs, etc. Database 360 may be configured to allow a user to create and modify a plurality of dairy end product records 365.

A dairy end product record 365 may be any type of database record configured to include a plurality of dairy end product information fields. Dairy end product information fields may be used to store information associated with a dairy end product created using dairy production system 100. Exemplary fields may include a dairy end product identifier, a dairy end product pricing information, a pricing risk allocation structure allocating pricing risk between the entities associated with dairy production system 100, tracing information for the dairy end product including identifiers of each entity associated with the production of the dairy end product, quality control information illustrating each entity's compliance with production requirements, etc. Each dairy end product record may include as many fields as needed to capture information needed to implement dairy production system 100.

Alternatively, as described above with reference to FIG. 2, information system 300 and database 360 may be implemented as a series of individual records that are never aggregated in a single system. Instead, each record is maintained by the entity within dairy production system 100 that is currently performing their function in the process of generating the dairy end product. For example, animal inputs provider may create a dairy end product record 365 to be associated with a shipment of animal feed having relatively uniform, defined characteristics. This shipment may then be provided to the dairy raw materials producer 120 to feed to dairy animals in the process of producing a batch of milk. The dairy end product record 365 may then be updated with the dairy raw materials producer identification along with the characteristics of the raw materials that were produced.

Both the centralized and distributed systems of creating the dairy end product records will generate dairy end product records that show the complete chain of production within dairy production system 100. Advantageously, the information within dairy end product record 365 may be utilized to provide numerous advantages in research, accounting, tracking, identifying high performing entities, etc.

Dairy end product record 365 may further include pricing agreement information, described above with reference to FIG. 2. Record 365 may further include accounting information. For example, record 365 may include prices and amount that were paid to and by each entity within dairy production system 100. The accounting information may be used in combination with the pricing agreement information to allocate profits and/or losses once the final cost of production for the dairy end product relative to the fixed price is known.

One advantage provided by dairy end product record 365 is the ability to identify entities within dairy production system 100 that consistently perform above the average with regard to providing output having superior characteristics, lower costs, greater production rate, lower production time, etc. Because all of the information is associated with each dairy end product, it will be relatively easy to identify production bottlenecks to improve efficiency.

Further, the dairy end product record 365 may be used to identify production patterns to increase predictability in providing the dairy end production, reducing the volatility associated with providing the dairy end product. For example, dairy end product producers 140 can better control the quality and characteristics for the dairy end product if they know the complete history of the dairy raw materials that they use as inputs. Production techniques may be used to compensate for different raw materials characteristics to produce a targeted dairy end product. This is true for each entity within dairy production system 100, smoothing some of the volatility in the dairy production process.

Dairy end product record 365 may also provide advantages in quality control and safety by providing a complete record of the production chain for the dairy end product, hereinafter production tracking information. Accordingly, wherein a quality control or a safety issue is identified, the complete production chain can be easily ascertained to aid in identifying the source of the quality control or safety problem. For example, where a dairy end product has been identified as being contaminated, dairy end product record 365 may be utilized to determine where along the production chain the contamination occurred. Once the source of the contamination occurs, this will facilitate identification of other dairy end products that may be similarly contaminated. Each dairy product information record 365 will include a clear record indicating whether it was produced by the determined source of contamination allowing for testing and/or removal of the end product from consumption.

The system and method is described herein with reference to drawings. These drawings illustrate certain details of specific embodiments that implement the systems and methods and programs. However, describing the system and method with drawings should not be construed as imposing on the system and method any limitations that may be present in the drawings. The present application contemplates methods, systems and program products on any machine-readable media for accomplishing its operations. The embodiments may be implemented using an existing computer processor, or by a special purpose computer processor incorporated for this or another purpose or by a hardwired system.

Embodiments within the scope of the present application include program products comprising machine-readable media for carrying or having machine-executable instructions or data structures stored thereon. Such machine-readable media can be any available media which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or stored desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments are described in the general context of method steps which may be implemented in one embodiment by a program product including machine-executable instructions, such as program code, for example in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing steps of the methods described herein. The particular sequence of such executable instructions or associated data structures represent examples of corresponding acts for implementing the functions described in such steps.

Embodiments may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PC's, minicomputers, mainframe computers, and the like. Embodiments may also be practiced in distributed computing environments where tasks are performed by local and remote processing devices that are linked (either by hardwired links, wireless links or by a combination of hardwired and wireless links) through a communications network. In a distributed computing environment, program modules may be located in both local and remote memory storage devices.

It should be noted that although the flow charts provided herein show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the application. Likewise, software and web implementations could be accomplished with standard programming techniques with rule based logic and logic to accomplish the various database searching steps, correlation steps, comparison steps and decision steps. It should also be noted that the word “component” as used herein and in the claims is intended to encompass implementations using one or more lines of software code, and/or hardware implementations, and/or equipment for receiving manual inputs.

The foregoing description of embodiments has been presented for purposes of illustration and description. It is not intended to be exhaustive or to limit the application to the precise form disclosed, and modifications and variations are possible in light of the above teachings or may be acquired from practice of the system and method. The embodiments were chosen and described in order to explain the principles in various embodiments and with various modifications as are suited to the particular use contemplated.

What is claimed is:

1. A method for allocating dairy end product pricing risk in a dairy production system, comprising:
providing a fixed price for a future period for a dairy end product to a retailer of the dairy end product;
determining a cost of production for the dairy end product, the cost of production including costs associated with each dairy production entity in the dairy production process; and
allocating the difference between the fixed price and the cost of production among each dairy production entity based on the sale of the dairy end product at the fixed price.

2. The method of claim 1, wherein the dairy end product is at least one of milk, cheese, butter, yogurt, cream products, and ice cream.

3. The method of claim 2, wherein the dairy end product include at least one quality characteristic, wherein the fixed price is set based on the quality characteristic.

4. The method of claim 1, wherein the dairy production entities includes at least an animal feed producer, a milk producer, and a dairy end product processor.

5. The method of claim 1, wherein the fixed price is variable based upon at least one external factor.

6. A system for managing dairy production information in a dairy production system, comprising:
a dairy information system including a plurality of dairy end product records, wherein each dairy end product record is associated with a particular dairy end product and includes dairy production information related to the dairy end product from each stage of a dairy production process used to generate the dairy end product.

7. The system of claim 6, wherein the dairy production information further includes a dairy end product pricing risk allocation configured to allocate profits and losses to entities involved in the production of the dairy end product.

8. The system of claim 6, wherein the dairy production information includes production tracking information configured to allow instant identification of all of the entities involved in the production of the dairy end product.

9. The system of claim 6, wherein the dairy end product is at least one of milk, cheese, butter, yogurt, cream products, and ice cream.

10. The system of claim 9, wherein the dairy end product include at least one quality characteristic, wherein the fixed price is set based on the quality characteristic.

11. The system of claim 6, wherein the dairy production entities includes at least an animal feed producer, a milk producer, and a dairy end product processor.

12. The system of claim 6, wherein the dairy production information includes a fixed price at which the dairy end product is to be sold.

13. The system of claim 12, wherein the fixed price is variable based upon at least one external factor.

14. A method for producing a dairy end product having end product requirements, comprising:
determining a method of dairy production configured to generate a dairy end product having characteristics that satisfy the end product requirements and optimize profitability;
determining an allocation of production outputs for implementation of the dairy production method among the entities in a dairy production system; and
determining an allocation of the profitability based at least in part on the costs associated the allocated production outputs allocated to each of the entities in the dairy production system.

15. The method of claim 14, further including generating production tracking information configured to allow instant identification of all of the entities involved in the production of the dairy end product.

16. The method of claim 14, wherein the dairy end product is at least one of milk, cheese, butter, yogurt, cream products, and ice cream.

17. The method of claim 16, wherein the dairy end product include at least one quality characteristic, wherein the fixed price is set based on the quality characteristic.

18. The method of claim 14, wherein the dairy production system entities includes at least an animal feed producer, a milk producer, and a dairy end product processor.

19. The method of claim 14, further including determining a fixed price at which the dairy end product is to be sold.

20. The method of claim 19, wherein the fixed price is variable based upon at least one external factor.
